(19) United States
(12) Patent Application Publication
(10) Pub. No.: US 2005/0180364 A1
(43) Pub. Date: Aug. 18, 2005

(54) Construction of projection operators for interference cancellation

(76) Inventors: Vijay Nagarajan, Boulder, CO (US); Louis L. Scharf, Fort Collins, CO (US); John K. Thomas, Erie, CO (US)

Correspondence Address: TENSORCOMM, INC., 1490 W. 121ST AVE., SUITE 105, WESTMINISTER, CO, 80234, US

(21) Appl. No.: 11/100,935

(22) Filed: Apr. 7, 2005

Related U.S. Application Data
(63) Continuation-in-part of application No. 10/247,836, filed on Sep. 20, 2002.
(63) Continuation-in-part of application No. 10/773,777, filed on Feb. 6, 2004.
(63) Continuation-in-part of application No. 10/686,829, filed on Oct. 15, 2003.
(63) Continuation-in-part of application No. 10/686,359, filed on Oct. 15, 2003.
(63) Continuation-in-part of application No. 10/294,834, filed on Nov. 15, 2002.

(51) Int. Cl. H04B 7/216

(52) U.S. Cl. 370/335

(57) ABSTRACT

Interference cancellation is performed in a CDMA receiver by projecting a received signal onto a subspace that is orthogonal to a signal selected for removal. An interference matrix or a combined interference vector is used to construct an interference-canceling projection operator. Confidence weights may be provided to components of the interference matrix or the interference vector based on estimation errors or relative strengths of interfering signals. Complexity reduction of the orthogonal projection operator may be achieved by providing for simplifying approximations that remove terms and operations. A linear transformation operator may be applied to the rows and/or columns of the interference matrix or the interference vector prior to construction of the orthogonal projection. Interference cancellation techniques may be configured for processing signals in a transmit-diversity system or a receive-diversity system using time and/or frequency-domain implementations and space and/or wave-number implementations of the transceiver.

### CROSS-REFERENCE TO RELATED APPLICATIONS

This application is a continuation-in-part of commonly owned and co-pending U.S. patent applications Ser. No. 10/773,777 (filed Feb. 6, 2004), Ser. No. 10/686,829 (filed Oct. 15, 2003), Ser. No. 10/686,359 (filed Oct. 15, 2003), Ser. No. 10/294,834 (filed Nov. 15, 2002), and Ser. No. 10/247,836 (filed Sep. 20, 2002), all assigned to the assignee hereof and hereby expressly incorporated by reference herein. This application incorporates by reference co-pending U.S. Pat. Appl. entitled “Interference Selection and Cancellation for CDMA Communications,” filed on, the entire disclosure and contents of which is hereby incorporated by reference.

### BACKGROUND

1. Field of the invention

The invention generally relates to the field of signal processing. More specifically the invention is related to effective and efficient algebraic projections of signals for the purpose of reducing the effects of interference.

2. Discussion of the Related Art

Digital filtering may be used to separate undesired components of a digital signal from desired signal components. For example, a digital filter may be used to pass frequency components of a desired signal while substantially blocking frequency components of an undesired signal.

In order to efficiently utilize time and frequency in a communication system, multiple-access schemes are used to specify how multiple users or multiple signals share a specified time and frequency allocation. Spread-spectrum techniques may be used to allow multiple users and/or signals to share the same frequency band and time interval simultaneously. Code division multiple access (CDMA) is an example of spread spectrum that assigns a unique code to differentiate each signal and/or user. The codes are typically designed to have minimal cross-correlation to mitigate interference. However, even relatively slight multipath effects can introduce cross correlations between codes and cause CDMA systems to be interference-limited. Digital filters that only pass or block selected frequency bands of a signal to filter out unwanted frequency bands are not applicable since CDMA signals share the same frequency band.

Multiple-access coding specified by CDMA standards provides channelization, or channel separability. In a typical CDMA wireless telephony system, a transmitter may transmit a plurality of signals in the same frequency band by using a combination of scrambling codes and/or covering (i.e., orthogonalizing) codes. For example, each transmitter may be identified by a unique scrambling code or scrambling-code offset. For the purpose of the exemplary embodiments of the invention, a scrambler (which is typically used in a W-CDMA system to scramble data with a scrambling code) is functionally equivalent to a spreader, which is typically used in CDMA2000 and IS-95 systems to spread data using short pseudo-noise (PN) sequences.

A single transmitter may transmit a plurality of signals sharing the same scrambling code, but may distinguish between signals with a unique orthogonalizing code. Orthogonalizing codes encode the signal and provide channelization of the signal. In W-CDMA, orthogonal variable spreading factor (OVSF) codes are used as multiple-access orthogonalizing codes for spreading data. CDMA2000 and IS-95 employ Walsh covering codes for multiple-access coding.

While CDMA signaling has been useful in efficiently utilizing a given time-frequency band, multipath and other channel effects cause these coded signals to interfere with one another. For example, coded signals may interfere due to similarities in codes and consequent correlation. Loss of orthogonality between these signals results in interference, such as co-channel and cross-channel interference. Co-channel interference may include multipath interference from the same transmitter, wherein a transmitted signal propagates along multiple paths that arrive at a receiver at different times, thereby degrading reception of a particular signal. Cross-channel interference may include interference caused by signal paths originating from other transmitters, thus degrading reception of a selected signal.

Interference can degrade communications by causing a receiver to incorrectly detect received transmissions, thus increasing a receiver's error floor. Interference may also have other deleterious effects on communications. For example, interference may diminish capacity of a communication system, decrease the region of coverage, and/or decrease maximum data rates. For these reasons, a reduction in interference can improve reception of selected signals while addressing the aforementioned limitations due to interference.

### SUMMARY OF THE INVENTION

A received communication signal comprises a signal of interest, as well as interfering signals and noise. One or more of the interfering signals may be selected for removal. Systems and methods described and illustrated herein provide for filtering by projecting a received signal onto a subspace that is orthogonal to a signal selected for removal.

In one embodiment of the invention, a confidence weight may be applied to at least one projection operator configured to cancel one or more interfering signals. A confidence weight may be based on any of various parameters or signal measurements, including the relative strengths of desired and interfering signals, or estimation errors for each interfering signal. Weighted interfering signals or weighted interference code spaces may be used to generate an interference matrix or a combined interference vector from which the orthogonal projection operator may be constructed.

Receiver embodiments of the invention may be configured for receiving signals from a transmit-diversity system. Furthermore, receiver embodiments comprising a plurality of receiver antennas may be configured to provide both interference cancellation and diversity combining.

One embodiment of the invention provides for constructing a projection operator from linear transformations of the row or column space of an interference matrix or a combined interference vector. A projection operator P_{S}^{⊥} may take the form P_{S}^{⊥}=(I−S(S^{H}S)⁻¹S^{H}), wherein I is an identity matrix, S is an interference matrix, and S^{H} is a Hermitian transpose of the interference matrix. If the received signal and the interference matrix are separated into real and imaginary parts, the projection operation may be expressed by a combination of up to eight real algebraic operations. Embodiments of the invention may provide for making at least one simplifying approximation to the projection operator P_{S}^{⊥} in order to reduce the number of operations, and thereby reduce the complexity of the projection operator.

In some embodiments of the invention, an oblique projection operator Q_{S}(R⁻¹)=S(S^{H}R⁻¹S)⁻¹S^{H}R⁻¹ or Q_{C}(P_{S}^{⊥})=C(C^{H}P_{S}^{⊥}C)⁻¹C^{H}P_{S}^{⊥} may be constructed. The term R denotes a shaping matrix, and C denotes a code matrix. An oblique projection may be advantageously configured to preserve at least one desired property of a signal of interest.

Embodiments disclosed herein may be advantageous to systems employing CDMA (e.g., cdmaOne, cdma2000, 1xRTT, cdma 1xEV-DO, cdma 1xEV-DV, and cdma2000 3x), W-CDMA, Broadband CDMA, Universal Mobile Telephone System (UMTS) and/or GPS signals. However, the invention is not intended to be limited to such systems, as other coded signals may benefit from similar advantages.

These and other embodiments of the invention are described with respect to the figures and the following description of the preferred embodiments.

### BRIEF DESCRIPTION OF THE DRAWINGS

FIG. 1A is a block diagram that illustrates a receiver embodiment configured to perform interference cancellation with respect to one aspect of the invention.

FIG. 1B illustrates an alternative receiver embodiment configured to perform interference cancellation according to a different aspect of the invention.

FIG. 2A illustrates several different embodiments of a projection receiver according to the present invention.

FIG. 2B shows several embodiments of a projection receiver configured to operate in a W-CDMA receiver.

FIG. 3A shows a receiver embodiment configured to process received W-CDMA signals.

FIG. 3B shows an alternative receiver embodiment of the present invention that provides for cross coupling between a plurality of interference selectors.

FIG. 3C illustrates an alternative receiver embodiment of the invention in which cross coupling of a plurality of interference selectors may include optimal combining.

FIG. 4A illustrates a functional embodiment of a weighted-decision combiner employed in some method and apparatus embodiments of the invention.

FIG. 4B shows a functional embodiment of a projection operator according to one aspect of the invention.

FIG. 5A illustrates an embodiment of a projection operator according to one aspect of the invention.

FIG. 5B illustrates an alternative embodiment of a projection operator.

FIG. 5C illustrates an embodiment of a weighted projection operator according to one aspect of the invention.

FIG. 5D illustrates an embodiment of a weighted projection operator according to another aspect of the invention.

FIG. 6 illustrates a Rake receiver embodiment of the invention.

FIG. 7 illustrates an alternate embodiment of the invention wherein projection cancellation is performed in a Rake receiver without a weighted-decision combiner.

FIG. 8A illustrates an iterative-feedback receiver according to one embodiment of the invention.

FIG. 8B shows an embodiment of the invention configured to perform a successive approximation of a projection operator.

### DESCRIPTION OF THE PREFERRED EMBODIMENTS

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the spirit and scope of the invention as defined by the claims.

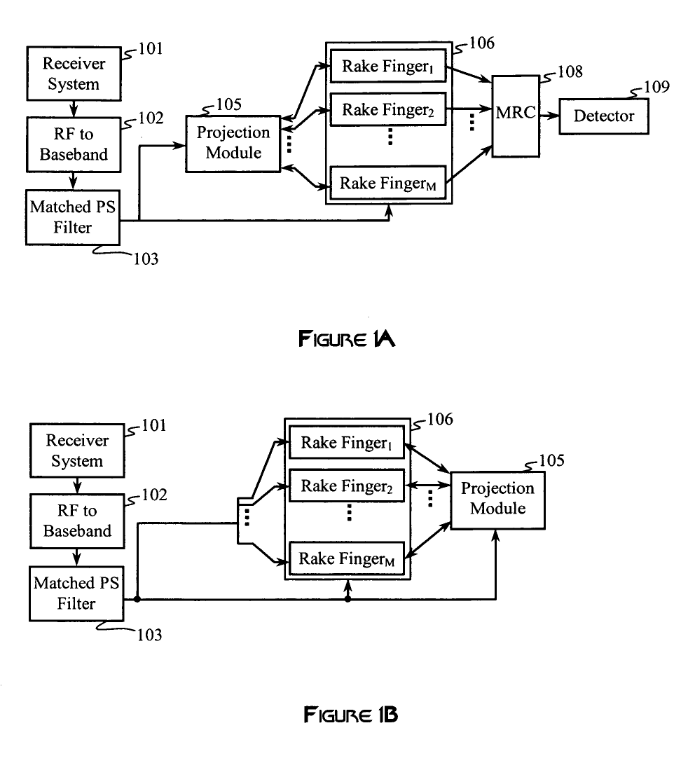

In FIG. 1A, a receiver system 101 is configured to receive at least one transmitted CDMA signal that has propagated through a communication channel. A transmitted signal typically comprises a superposition of data-bearing user (or traffic) subchannels and at least one control channel. Each user subchannel may be scaled by a predetermined gain in relation to that user's subchannel conditions. The user subchannels are individually spread using one of N orthogonal channelization codes. The value of N varies based on the standards and the CDMA network capabilities. For example, in a typical CDMA 2000 system, this value may be set at 64. Examples of orthogonalizing codes include Walsh codes and Orthogonal Variable Spread Factor (OVSF) codes. Alternative orthogonalizing codes may be used.

Transmission signals comprising a plurality of subchannels are typically spread with a covering or scrambling code, such as a PN sequence. Scrambling codes may include real or complex codes. Such scrambling codes may be specific to particular transmitters in order to mitigate inter-sector or inter-cell interference. Particular types of scrambling codes may be favored due to their auto-correlation properties. For example, preferred scrambling codes may have a sharp (1-chip wide) autocorrelation peak to facilitate code synchronization. Received transmission signals are typically characterized by differential delays and complex gains due to multipath and/or transmit diversity.

The receiver system 101 may include a single antenna, or a plurality of antennas that may be used for receiver diversity and/or beam-forming operations. The receiver system 101 may provide for any well-known RF front-end operation, such as amplifying a received signal, filtering a received signal, adjusting phase or delay of a received signal, and/or combining signals received from a plurality of receiver chains. Other well-known RF front-end operations may be performed.

An RF-to-baseband processor 102 is configured to convert a received RF signal to a baseband signal, such as a digital baseband signal. The RF-to-baseband processor 102 may include various well-known receiver-processing components, such as a mixer, a local oscillator, IF processing circuitry, filters, a direct-conversion system, an ADC, etc. An optional matched pulse-shaping (PS) filter 103 or an equalizer (not shown) may be matched to at least one corresponding pulse-shaping filter in the transmitter.

An output of the matched pulse-shaping filter 103 is coupled to a Rake receiver 106 and a projection module 105. The Rake receiver 106 includes a plurality M of Rake fingers configured to demultiplex and demodulate the baseband signals with respect to the signal information. For the purposes of the present invention, the term “finger” refers to a signal processing entity in a Rake receiver that may be capable of tracking and demodulating a signal. A Rake receiver is comprised of multiple fingers, each of which is assigned to either a unique source or a multipath version of an assigned source. The purpose of a Rake receiver is to combine multipath signals in order to increase the SNR.

Each finger of the Rake receiver 106 made include one of a plurality of PN generators (not shown) for providing a timing offset corresponding to the finger's assigned multipath component. Timing offsets may preferably account for any system latency, such as may be introduced by the projection module 105. The Rake fingers may be configured to supply PN codes, symbol boundaries, and chip boundaries to the projection module 105.

The projection module 105 is configured to cancel inter-symbol interference (ISI), inter-channel interference (ICI), and/or co-channel interference, which typically arises from pulse shaping, multipath in the channel, multiple carriers, and/or interference from multiple base stations (e.g., during a hand off). The projection module 105 is also configured to receive signal-timing information from the searcher/tracker module 104. In this embodiment, the projection module 105 produces an interference-canceled signal for each Rake finger (not shown) in the Rake receiver 106. The Rake receiver 106 typically includes a combiner (not shown) to produce linearly combined demodulated baseband signals. Alternatively, non-linear (e.g., iterative) combining may be performed.

The projection module 105 may include a Rake receiver structure (not shown). However, unlike the Rake receiver 106, which typically performs reception with respect to only one orthogonalizing (e.g., Walsh) code, the projection module 105 may be configured to perform Rake reception for a plurality of orthogonalizing codes. One or more of the codes may be identified as interfering signals, which are subsequently provided with baseband transmission processing, channel emulation, and baseband receiver processing prior to being used to construct at least one projection operator.

FIG. 1B illustrates an alternative receiver embodiment of the invention in which the projection module 105 is placed after the Rake receiver 106. The projection module 105 processes signals received from the Rake receiver 106 and, optionally, the matched filter 103. In addition to supplying PN codes, symbol boundaries, and chip boundaries to the projection module 105, the Rake receiver 106 provides the projection module 105 with Rake finger outputs that would otherwise be processed by the MRC 108.

In an exemplary embodiment, the projection module 105 may be configured to orthogonally project at least one Rake finger output relative to at least one interfering signal space derived from at least one other finger. Alternatively, the projection module 105 may orthogonally project the filter 103 output relative to at least one interfering signal space derived from at least one of the fingers. Furthermore, the projection module 105 may select between a Rake finger output and an interference-cancelled (i.e., projected) output, and route the selected signal for further processing. For example, the selected signal may be decoded with an orthogonalizing code corresponding to at least one signal of interest, combined in an MRC, and processed by a detector.

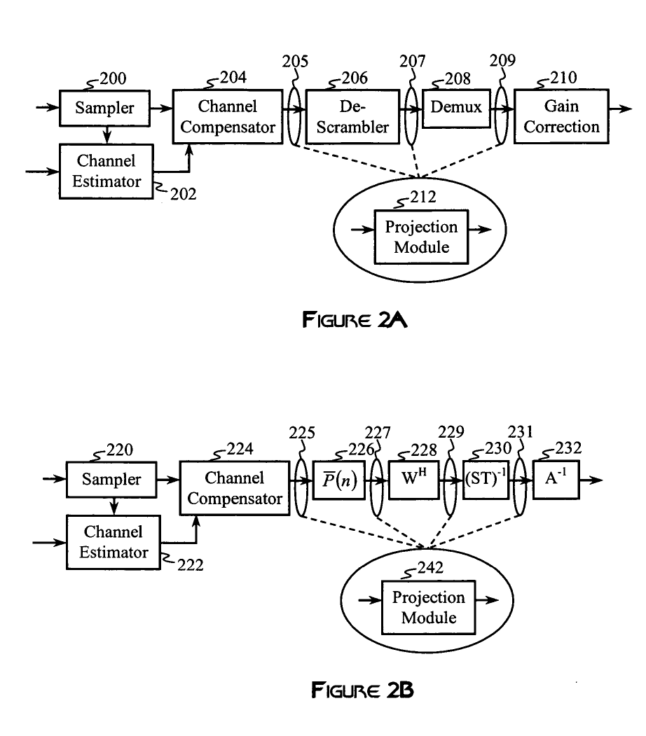

Embodiments of the invention may provide for various arrangements of combining and interference cancellation. For example, the projection module 105 may be configured to cancel interference on Rake signals prior to combining and/or following combining. Further embodiments of the invention may place the projection module 105 at any of various positions within the Rake receiver 106, such as illustrated in FIGS. 2A and 2B.

FIG. 2A illustrates several different embodiments of a projection receiver according to the present invention. A sampler 200 down-samples an input baseband signal with respect to signal information (e.g., path delay, symbol boundaries, and chip boundaries, etc. corresponding to one or more multipath delays) received from the searcher/tracker 104 to produce a sampled signal. Received pilot signals and the sampled signal are coupled to a channel estimator 202 to produce a complex channel estimate, which may optionally be used by a channel compensator 204 to produce a channel-compensated receive signal.

The channel-compensated receive signal is processed by a descrambler 206 (which removes the scrambling code), a demultiplexer 208 (which removes at least one of the orthogonal channelization codes), and an optional gain-correction module 210 (which may compensate for gain applied to one or more user channels by a transmitter). A projection module 212 is also provided, which may be included in the Rake finger at position 205 (coupled between the channel compensator 204 and the descrambler 206), position 207 (coupled between the descrambler 206 and the demultiplexer 208), and/or position 209 (coupled between the demultiplexer 208 and the gain-correction module 210). The projection module 212 receives as a control signal a digital baseband signal that undergoes the same signal-processing operation(s) as the interference signals selected to be projected out of the digital baseband signal. The projection module 212 may optionally receive delay information from the searcher/tracker 104.

FIG. 2B shows several embodiments of a Rake finger configured to operate in a W-CDMA receiver. A signal output from a matched baseband filter (not shown) is sampled by a sampler 220. Primary common pilot channel (P-CPICH) data bits, the P-CPICH OVSF code, and the sampled signal are coupled to a channel estimator 222 to produce a complex channel estimate, which may optionally be used by a channel compensator 224 to produce a channel-compensated receive signal. If transmit-diversity methods are employed, secondary common pilot channel (S-CPICH) data bits and the S-CPICH OVSF code may be provided to the channel estimator 222. The S-CPICH may also be used for other decoding processes.

In a space-time transmit diversity (STTD) system, a primary path is provided with a P-CPICH and a diversity path is provided with an S-CPICH. Either the S-CPICH or the P-CPICH signal may be used by the channel estimator 222 depending on whether a primary path or a multipath component is being processed by the Rake finger. Similarly, pilot bits on the dedicated physical channel (DPCH) may be used for antenna weight determination, as well as other receiver-processing functions that are well known in the art. If closed loop transmit diversity is employed, channel compensation includes compensating for transmit-antenna weights in addition to channel effects.

A descrambler 226 may perform an inner product operation employing a vector derived from a complex conjugate of a transmitted Gold code corresponding to a signal path of interest. A demultiplexer 228 may be configured to perform an operation employing a complex conjugate of a channelization matrix W that was used to encode transmitted signals. An optional inverse space-time processor 230 may be configured to process a received diversity path of a signal transmitted in an STTD system. The receiver also may include an optional inverse-gain operator 232.

A projection module 242 may be included in the Rake finger at one or more positions, such as position 225 (coupled between the channel compensator 224 and the descrambler 226), position 227 (coupled between the descrambler 226 and the demultiplexer 228), position 229 (coupled between the demultiplexer 228 and the inverse space-time processor 230), and/or position 231 (coupled between the inverse space-time processor 230 and the gain-correction module 232). The projection module 242 receives as its control signal a digital baseband signal that undergoes the same signal-processing operation(s) as the interference signals selected to be projected out of the digital baseband signal. The projection module 242 may optionally receive delay information from the searcher/tracker 104

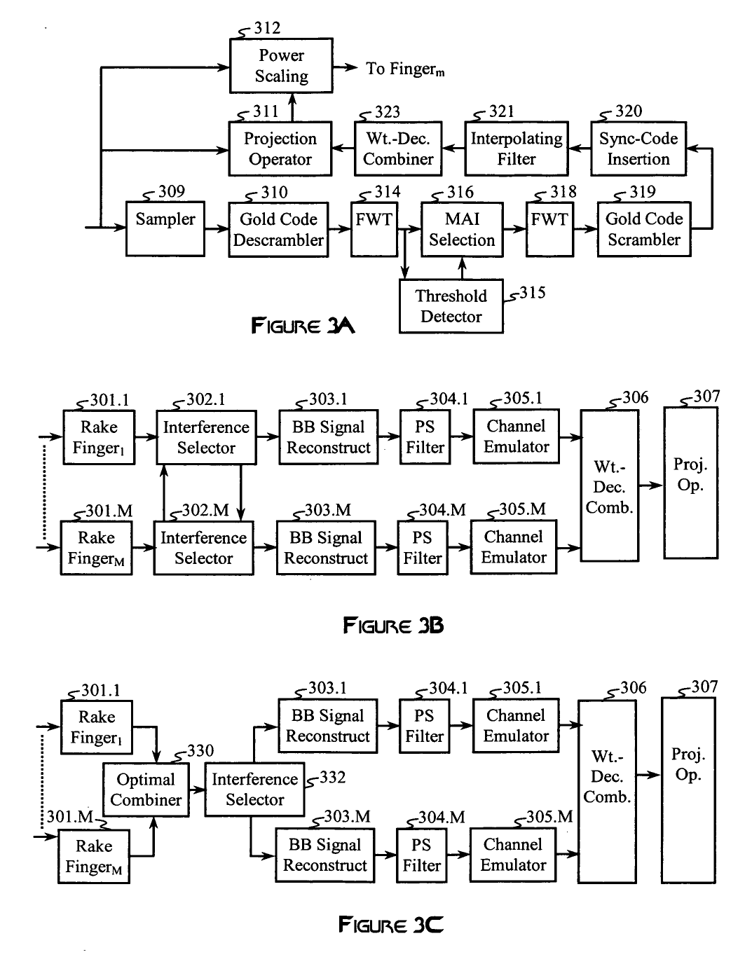

FIG. 3A shows an interference canceller that may be coupled to an m^{th} finger (not shown) of a Rake receiver employed in a W-CDMA system. A received digital baseband signal is input to a Gold code descrambler 310 after being processed in a sampler 309. An optional channel compensator (not shown) may be employed to perform channel compensation prior to a fast Walsh transform (FWT) 314, which may be configured to demultiplex the descrambled baseband signal to produce at least one symbol estimate. In W-CDMA, it is common for the FWT 314 to employ a spreading factor of 128. However, other spreading factors may be used.

The at least one symbol estimate may be passed through at least one of a threshold detector 315 (such as a P-CCPCH threshold detector) and a multiple-access interference (MAI) selection module 316. The threshold detector 315 may use a channel known to be present, such as a common channel (e.g., the P-CCPCH), to generate a threshold value. For example, P-CCPCH symbols may be separated into in-phase (I) and quadrature-phase (Q) parts, and then a function of these parts, such as a sum of the absolute values of the I and Q parts may be averaged over a plurality of symbols. Similarly, other common channels (or combinations thereof), including P-CPICH, PICH, AICH, S-CCPCH, S-PICH, etc., may be used. In some embodiments of the invention, one or more traffic channels may be used as thresholding references to produce one or more threshold values. Alternatively, a predetermined constant value may be selected as a threshold. In some embodiments, a combination of thresholding references (e.g., a threshold derived from one or more traffic channels and a predetermined constant-value threshold) may be employed.

The MAI selection module 316 typically identifies a plurality of user (i.e., traffic) channels present in a particular path. Furthermore, signal distortions due to channel effects and/or diversity processing may be accounted for either directly or indirectly. A decision to include or exclude a particular channel may be made by examining the associated power resolved by that channel. If a channel is to be excluded from the interference space, then the power of that Walsh channel may be set to zero or simply ignored. This operation will result in that channel being excluded from the construction of an interference matrix.

In one embodiment, the MAI selection module 316 may use a sum of absolute values of I and Q components of the at least one symbol estimate for a particular sub-channel. The sum may be compared to at least one threshold for determining the presence or absence of that particular channel. Data values corresponding to measurements that don't pass the threshold criterion may optionally be forced to zero. Data that pass the threshold criterion is spread by an FWT 318. An optional channel emulator (not shown) may be employed to approximate channel distortions observed in the digital baseband signal. The resulting spread (and optionally distorted) signal is scrambled in a Gold code scrambler 319 to produce at least one selected interference signal.

An optional sync-code insertion module 320 may be employed for inputting synchronization codes, such as P-SCH and S-SCH codes in a W-CDMA system. An interpolating filter 321 processes each selected interference signal prior to processing by a weighted-decision combiner 323. In one embodiment, the interpolating filter 321 closely models the combined function of transmit and receive pulse-shaping filters (not shown). The weighted-decision combiner 323 may select and sum a plurality of the selected interference signals from various interfering multipaths to produce a composite interference vector (CIV).

A CIV may refer to an interference vector formed as a linear combination of interference vectors scaled according to each channel's relative amplitude. One advantage to producing a CIV is that it provides for rank reduction of the S matrix while still enabling cancellation of multiple interfering channels. This rank reduction allows for a single rank interference matrix (i.e., the CIV) to cancel a plurality of signal vectors.

An interference-cancelled signal is produced by a projection operator 311 configured to orthogonally or obliquely project the digital baseband signal onto a subspace that is substantially orthogonal to an interference subspace determined from the CIV. Interference cancellation may be performed over a data-symbol interval, or some integer multiple or a fraction of the data-symbol interval. Interference cancellation may be performed over a sample interval in which there is a plurality of samples per chip. The interference-cancelled signal may be coupled into an optional power-scaling block 312 to adjust the power of the interference-cancelled signal to match that of the digital baseband signal. Optionally, a signal selection block (not shown) may be configured to select either the interference-cancelled signal or the received digital baseband signal based on at least one signal-quality criterion.

FIG. 3B shows a projection receiver according to an embodiment of the present invention. A received baseband signal is input to a plurality M of Rake fingers 301.1-301.M, which may be configured to process all of the orthogonalizing codes in a given system. Each of a plurality of interference selectors 302.1-302.M is configured to select channels that are likely to contribute MAI to at least one signal of interest. For example, sub-channels associated with signal paths having a predetermined range of delays, correlations with a given sub-channel, and/or signal strengths may be identified as potentially interfering channels.

The invention may employ various selection criteria to determine which channels may produce MAI and determine which projections to use. The interference selectors 302.1-302.M are typically configured to produce a symbol-level output for one or more MAI channels. The aforementioned techniques are described more fully in a co-pending U.S. Pat. Appl. entitled “Interference Selection and Cancellation for CDMA Communications,” and assigned to the assignee of the present invention. The contents of this U.S. Patent Application are incorporated herein by reference.

In an exemplary embodiment of the invention, interference selectors 302.1-302.M may employ threshold detection in which the instantaneous or averaged signal power for individual receive channels is compared to a predetermined threshold to determine which channels should be considered to be active. In another embodiment of the invention, the interference selectors 302.1-302.M may employ a signal-processing algorithm that uses correlations and principles of multi-variate statistical inference to identify active MAI channels and their complex gains. The number of MAI channels identified may be bounded by a predetermined maximum number, the number of channels determined to exceed a predetermined power threshold, and/or the number of channels required to optimize at least one predetermined measure of performance. In some other embodiments of the invention, the interference selectors 302.1-302.M may be configured to identify common (e.g., control) channels that are known to be present. Alternative interference-selection procedures may be implemented without departing from the scope and spirit of the invention.

In a preferred embodiment, the interference selectors 302.1-302.M are configured to identify a common channel that is always present and use an average function of the common channel's complex amplitude as a comparison metric for other channels. For example, the average function may include the magnitude-squared of the absolute value of the real and imaginary parts of the complex amplitude. In IS 95/CDMA 2000, the synchronization channel can be used as the common channel. In W-CDMA, the P-CPICH or P-CCPCH may be used. Those skilled in the art should appreciate that there are other channels and functions that may be used in conjunction with the embodiments of the invention, and that the scope of the invention should not be limited by the constraints of the channel-selection procedure employed.

Two or more of the interference selectors 302.1-302.M may be coupled together such that decisions for Walsh selection of one path may be influenced by a detection process for at least one other path. For example, when two or more multipath components from a base station are processed in a Rake receiver, it may be advantageous to use the strongest multipath for interference selection. Thus, the interference selector 302.1-302.M corresponding to the strongest multipath may be used to determine the MAI channels for each path.

Optional channel emulators 305.1-305.M may provide complex gains to the selected channel outputs such as to reproduce the effects of channel distortion resulting from the propagation channel between the transmitter(s) and the receiver. A baseband signal reconstruction module 303.1-303.M processes the MAI channel symbols to produce a signal that is substantially in the same form as the transmitted baseband signal. For example, each baseband signal reconstruction module 303.1-303.M may provide scaling, orthogonalizing codes, and scrambling codes to the MAI channel symbols.

Outputs of the baseband signal reconstruction module 303.1-303.M may be coupled to an optional pulse-shaping filter 304.1-304.M. In an alternative embodiment, an interpolating filter may be used, such as an interpolating filter configured to approximate the combined effects of transmit and receive pulse-shaping filters. In an exemplary embodiment, a linear interpolator may be used. Another exemplary embodiment may employ a raised-cosine interpolating filter having a predetermined roll-off factor.

A weighted-decision combiner 306 provides confidence weights to input MAI-channel signals to produce a weighted MAI-channel output that is coupled to a projection operator 307. The received baseband signal is also coupled into the projection operator 307, which produces at least one interference-canceled signal. Canceled signals produced by the projection operator 307 are output to Rake fingers of a receiver.

FIG. 3C illustrates an alternative embodiment of the invention in which signals received from at least two of the plurality of Rake fingers 301.1-301.M are combined in an optimal combiner 330 to produce a combined signal. An interference selector 332 is configured to process the combined signal to identify and select one or more MAI channels. If the Rake fingers 301.1-301.M are assigned to signals transmitted by different transmitters (e.g., base stations), it may be advantageous to combine signals from Rake fingers assigned to a common transmitter. Thus, the optimal combiner 330 may include one or more combiners, each configured for optimally combining multipath signals received from a particular transmitter. The one or more selected MAI channels are then processed by the channel emulators 305.1-305.M. Signal processing of the channel emulated signals may proceed in a similar manner as discussed with respect to FIG. 3B.

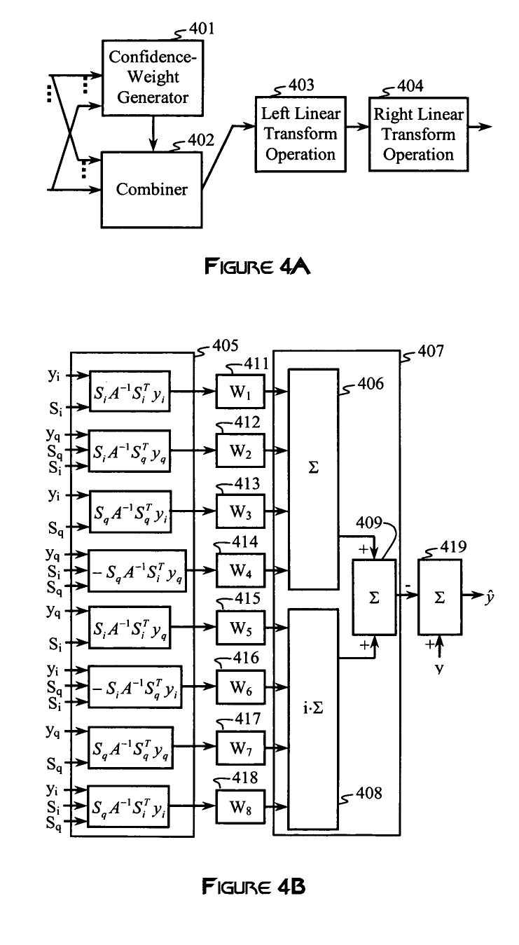

FIG. 4A illustrates a functional embodiment of the weighted-decision combiner 306. The MAI-channel signals from a particular finger are coupled into a confidence-weight generator 401 that determines the reliability of each MAI signal path and expresses the reliability as one of a predetermined set of confidence weights for scaling the MAI signal paths. For each Rake finger 301.1-301.M, the confidence-weight generator 401 may produce a vector of confidence weights wherein each weight corresponds to the other Rake fingers. For example, for Rake finger 301.1, a corresponding vector may comprise confidence weights for Rake fingers 301.2-M.

The confidence-weight generator 401 may comprise any of various DSP algorithms and correlation functions to determine the weights. In an exemplary embodiment of the invention, the confidence-weight generator 401 may be configured to determine relative strengths of the received paths and determine the weights from the binary set of {0,1}. For example, if a desired signal path is stronger than an interfering path by a given factor, then the interferer is assigned a weight of 0, else the interferer is assigned 1. Because signal paths that are below a predetermined threshold may not be considered reliable for cancellation, they may be excluded from the cancellation process.

In other embodiments of the invention that employ large weight constellations, relative weights may be assigned to the interfering paths such that paths with high estimation errors may be given a lesser weight. For example, a path 6dB below the desired signal path may be assigned a smaller confidence measure than a path that is only 3dB below the desired signal path. A combiner 402 weights and combines the MAI-channel signals to output a combined interference matrix. Alternatively, the combiner 402 may perform a vector addition of the weighted interference vectors to produce an output interference vector, such as a CIV.

The output of the combiner 402 may include a CIV or an S-matrix of interference vectors selected for cancellation. An S-matrix may be coupled to an optional left linear transformation 403 (LLT) or to an optional right linear transformation 404 (RLT). The LLT 403 and RLT 404 differ in that the former is a linear transformation applied to the row space of an interference matrix S, and the latter is a linear transformation applied to the column space of the interference matrix. Embodiments of the invention may advantageously employ any type of linear transformation on the column space of the interference matrix. Such embodiments may exploit the fact that complex projection operations performed by the projection operator 307 are invariant to non-singular RLTs. If the output of the combiner 402 is a vector, the LLT 403 and/or the RLT 404 provide a real or complex scaling factor.

Singular RLTs may be used to construct low-dimensional interference sub-spaces to be used in producing low-dimensional projections. A CIV is a one-dimensional interference vector constructed from a higher-dimensional interference matrix S. A projection P_{S}^{⊥} constructed from the CIV is an (N-1) dimensional projection, whereas a projection P_{S}^{⊥} constructed from an interference matrix S is (N-M) dimensional, where S is a matrix comprising M interfering vectors. The construction of CIVs and S-matrices is well known in the art, such as described in U.S. patent Application Ser. No. 10/294,834, entitled “Construction of an interference matrix for a coded signal processing engine,” which is incorporated by reference in its entirety.

For systems configured to produce a vector from S, the RLT is a vector. A single-column RLT may be used to provide a linear transformation, such as (but not limited to) channel emulation. The projection is invariant to complex scaling of the RLT. Some embodiments of the invention may employ RLT matrices, such as to provide multiple linear combinations, or multiple CIVs, of the active Walsh Channels.

FIG. 4B shows a functional embodiment of a projection operator according to one aspect of the invention. An orthogonal projection operator P_{S}^{⊥} is typically configured to project an input signal y onto a subspace that is substantially orthogonal to an interference subspace S (i.e., one or more selected interfering signals represented as a matrix or as a vector comprising a linear combination of selected interfering signals). Thus, the projection operator projects out at least some of the interference in the input signal y relative to at least one signal of interest, resulting in an interference-cancelled signal ŷ. An algebraic representation of the projection is given by:
\hat{y}=(I−S)(S^{H}S)⁻¹S^{H})y,
where I is an identity matrix.

If S and y are complex-valued, then the projection can be decomposed into eight real algebraic operations 405. For each of the operations 405, an input comprises some combination of the input signal's in-phase and quadrature components yᵢ and y_{q}, and the in-phase and quadrature components Sᵢ and S_{q}. The operations performed on these inputs are represented algebraically by the eight operations 405, where the term A is:
A=S^{H}S,
where S=Sᵢ+iS_{Q} is the complex representation of in-phase and quadrature interference matrices. The terms in-phase and quadrature may include any two channels in a two-channel processing system, whether or not there is an associated quadrature demodulator.

Outputs from the operations 405 are multiplied by weights 411-418. In the case in which the weights 411-418 have values of 1 or 0, the weights 411-418 merely represent a selection process with respect to which operations 405 are performed. Thus, in some embodiments of the invention, the weights 411-418 are not intended to provide a literal interpretation of how signal processing is performed. For example, in some embodiments of the invention, it is not desirable to perform one or more of the operations 405 only to have the corresponding output zeroed out by the weighting process 411-418. Rather, it may be preferable to simply avoid performing the corresponding one or more operations 405. A weight-value of one may correspond to an implementation of a particular one of the operations 405.

The outputs from the operations 405 are combined in a combiner 407. For example, the real in-phase outputs are summed 406 to produce a combined real output. The quadrature outputs are summed 408 to produce a combined quadrature output. The combined in-phase and quadrature outputs are combined in a combiner 409 to produce a combined interference vector, which may be represented as a complex vector. In some embodiments, the complex vector may be expressed in terms of magnitude and phase angles. The combined interference vector is subtracted 419 from the input signal y to produce the interference-cancelled signal ŷ, which may be coupled into a receiver.

In some embodiments of the invention, the operations 405 may be simplified without a significant loss in performance by making the following assumptions:
1. In-phase and quadrature parts of S have low cross correlations.
2. In-phase and quadrature parts of y have low cross correlations.
3. There is low correlation between the in-phase part of S and the quadrature part of y.
4. There is low correlation between the in-phase part of y and the quadrature part of S.
   This corresponds to the weights 413-416 being set to zero. Besides reducing the number of operations 405 by half, the matrix A becomes a real matrix, which is simpler to invert.

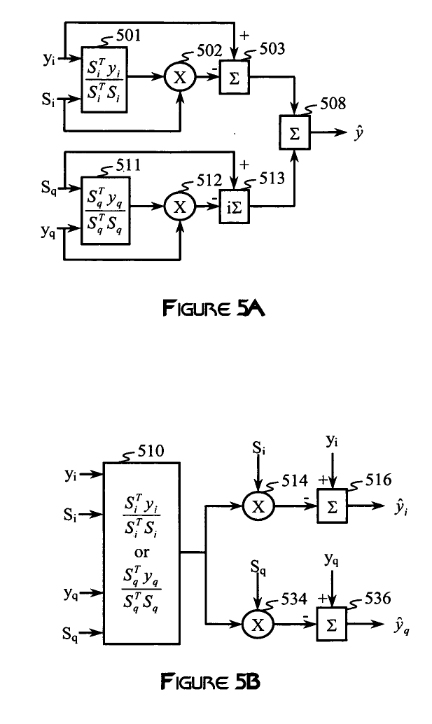

In one embodiment of the invention, the matrix A may be simplified to:
A=Sᵢ^{T}S₁+S_{q}^{T}S_{q}
Furthermore, correlation properties of the scrambling codes may sometimes be exploited to provide the following approximations:
Sᵢ^{T}Sᵢ=S_{q}^{T}S_{q} and Sᵢ^{T}yᵢ=S_{q}^{T}y_{q}
In such cases, the system shown in FIG. 4B may be simplified, such as represented by FIGS. 5A and 5B.

In some embodiments of the invention, S may be a vector representing a combination of interfering paths and MAI channels in a CDMA system. Thus, Sᵢ and S_{q} are vectors. In CDMA, the scrambling codes (e.g., PN codes for CDMA 2000/IS 95 and Gold Codes in W-CDMA) have excellent auto-correlation properties. This enables approximations of Sᵢ^{T}Sᵢ=S_{q}^{T}S_{q} and Sᵢ^{T}y_{i=S}_{q}^{T}y_{q} to be accurate for certain conditions. For example, the assumption Sᵢ^{T}yᵢ=S_{q}^{T}y_{q} is typically valid when a received signal has a relatively high signal-to-noise ratio. Furthermore, cross correlations between in-phase and quadrature components can often be regarded as relatively small. Thus, the aforementioned assumptions enable a simplified projection operation.

FIG. 5A illustrates an embodiment of a simplified projection operator in which values yᵢ and Sᵢ are input to a first operator 501 configured to perform a first operation
(Sᵢ^{T}Sᵢ)⁻¹Sᵢ^{T}yᵢ.
When Sᵢ is a vector, the first operation can be expressed by

$$\frac{{S}_{i}^{T} {y}_{i}}{{S}_{i}^{T} {S}_{i}} .$$

The values y_{q} and S_{q} are input to a second operator 511 to perform a second operation:
(S_{q}^{T}S_{q})⁻¹S_{q}^{T}y_{q},
which can be expressed by

$$\frac{{S}_{q}^{T} {y}_{q}}{{S}_{q}^{T} {S}_{q}}$$

when S_{q} is a vector.

The output of the first operator 501 is multiplied 502 by Sᵢ and then subtracted 503 from yᵢ to produce an interference-cancelled in-phase signal ŷᵢ. Similarly, the output of the second operator 511 is multiplied 512 by S_{q} and then subtracted 513 from y_{q} to produce an interference-cancelled quadrature signal ŷ_{q}. The interference-cancelled in-phase and quadrature parts may be combined 508 in a complex algebra to produce a complex interference-cancelled signal ŷ=ŷᵢ+iŷ_{q}.

FIG. 5B illustrates an alternative embodiment of the invention in which an operator 510 is configured to perform at least one of two operations, including the following:
(Sᵢ^{T}yᵢ)/(Sᵢ^{T}Sᵢ) and (S_{q}^{T}y_{q})/(S_{q}^{T}S_{q})
The output of operator 510 is multiplied 514 by Sᵢ and then subtracted 516 from yᵢ to produce an interference-cancelled signal ŷᵢ. Similarly, the output of operator 510 is multiplied 534 by S_{q} and then subtracted 536 from y_{q} to produce an interference-cancelled signal ŷ_{q}. Although many of the preferred embodiments of the invention have been illustrated and described with respect to a vector version of the interference S, those skilled in the art will recognize that appropriate adaptations and variations of the above-recited embodiments may be provided for any matrix version of the interference S. Furthermore, each of the previously described embodiments may include means for selecting which of a set of signals, including an interference-cancelled signal ŷ and an input signal y, may be coupled to further processing means, such as a Rake receiver.

As an alternative to the orthogonal projection operator P_{S}^{⊥}, the embodiments of the invention may provide an oblique projection operator Q_{S}^{⊥}. An orthogonal projection typically transforms the signal of interest. However, an oblique projection may be advantageously configured to preserve at least one predetermined property of the signal of interest by accounting for the angle between the interference and the signal of interest. Thus, an oblique projection may avoid decision errors in a signal-of-interest estimate that can result from an orthogonal projection.

In one embodiment of the invention, an interference-rejecting oblique projection operator Q_{S}^{⊥}(R⁻¹) may be expressed by
Q_{S}^{⊥}(R⁻¹)=(I−S(S^{H}R⁻¹S)⁻¹S^{H}R⁻¹),
where S is an interference matrix, and matrix R may represent correlation of the signal of interest, correlation between the signal of interest and the interference, or correlation of the received signal. One may obtain R by using correlation functions and other elements of statistical signal processing that are well known in the art. One of ordinary skill in the art should appreciate that an oblique projection operator may be constructed from a CIV, which is a vector t of the form t=Sb, where b is a vector-valued RLT.

In one embodiment of the invention, the projection receiver may be configured to produce a matrix R that describes the correlation between the signal of interest and the interference. A perfect estimate of R makes Q_{S}^{⊥}(R⁻¹)y a best linear unbiased estimator of the interference. An accurate (but less than perfect) estimate of R produces an empirical best linear unbiased estimator, which substantially projects interference out of the direction of the desired code space. In yet another embodiment of the invention, the projection receiver may be reconfigured to produce an orthogonal projection by setting the matrix R to be an identity matrix I.

In another embodiment of the invention, an oblique projection operator Q_{C}^{⊥}(P_{S}^{⊥}) may be expressed by
Q_{C}(P_{S}^{⊥})=C(C^{H}P_{S}^{⊥}C)⁻¹C^{H}P_{S}^{⊥},
where P_{S}^{⊥} is an orthogonal projection operation and C is a signal matrix of interest (e.g., a spread-spectrum code matrix). In this case,
Q_{C}^{⊥}(P_{S}^{⊥})C=C and Q_{C}^{⊥}(P_{S}^{⊥})S=0,
thus removing the interference and passing the signal of interest undistorted.

In one Rake receiver embodiment of the invention, interference cancellation for a particular (i.e., selected) Rake finger, or multipath, includes determining interference from one or more non-selected Rake fingers (e.g., multipaths). In the case where the signal of interest is a traffic channel, the signal matrix of interest C may be a corresponding Walsh code c scrambled with a particular PN code. The interference space S will comprise a compound vector emulating interference from paths assigned to the one or more non-selected Rake fingers that are likely to interfere with the signal of interest.

FIG. 5C illustrates a weighted-projection embodiment of the invention in which at least one input to the combiner 503 and/or 513 is weighted with at least one confidence weight by optional weighting modules 521-524. Similarly, FIG. 5D shows weighting modules 525 and 526 configured to weight an input to combiner 516 and weighting modules 545 and 546 configured to weight an input to combiner 536.

A weighted projection is a scaling of a projection based on at least one reliability estimate of the projection. For example, an orthogonal projection operator that fails to meet a predetermined reliability threshold may be weighted by a factor β<1. Thus, some embodiments of the invention may provide a pseudo-projection operation of the form
P_{S}^{⊥}=I−βP_{S}.

Another embodiment of the invention may provide for a weighted combination of y and P_{S}^{⊥}y based on reliability estimates.
y^{⊥}=(α₁I+α₂P_{S}^{⊥})y,
where α₁ and α₂ represent reliability weights. Those skilled in the art should appreciate that many different techniques may be used to calculate reliability weights. For example, the reliability weights may be determined from signal measurements, such as SNR or probability of error. Reliability weights are also known in the art as confidence measures. In some embodiments of the invention, a weighted oblique projector may be expressed by
y^{⊥}=(α₁I+α₂Q)y

The invention is not intended to be limited to the preferred embodiments. Furthermore, those skilled in the art should recognize that the method and apparatus embodiments described herein may be implemented in a variety of ways, including implementations in hardware, software, firmware, or various combinations thereof. Examples of such hardware may include Application Specific Integrated Circuits (ASICs), Field Programmable Gate Arrays (FPGAs), general-purpose processors, Digital Signal Processors (DSPs), and/or other circuitry. Software and/or firmware implementations of the invention may be implemented via any combination of programming languages, including Java, C, C++, Matlab™, Verilog, VHDL, and/or processor specific machine and assembly languages.

Computer programs (i.e., software and/or firmware) implementing the method of this invention may be distributed to users on a distribution medium such as a SIM card, a USB memory interface, or other computer-readable memory adapted for interfacing with a consumer wireless terminal. Similarly, computer programs may be distributed to users via wired or wireless network interfaces. From there, they will often be copied to a hard disk or a similar intermediate storage medium. When the programs are to be run, they may be loaded either from their distribution medium or their intermediate storage medium into the execution memory of a wireless terminal, configuring an onboard digital computer system (e.g. a microprocessor) to act in accordance with the method of this invention. All these operations are well known to those skilled in the art of computer systems.

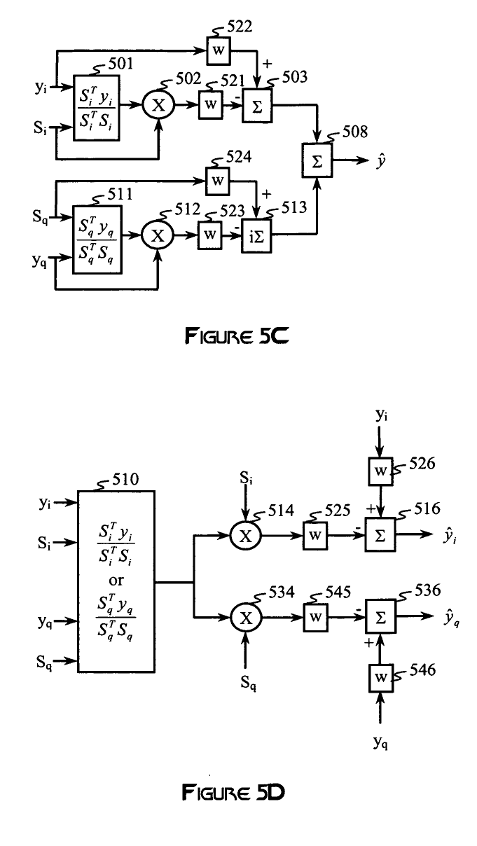

FIG. 6 illustrates an alternate embodiment of the invention wherein the system is configured to perform orthogonal projections inside a Rake receiver. A received baseband signal is input to a plurality M of Rake fingers 601.1-601.M. Each of a plurality of interference selectors 602.1-602.M is configured to select channels that are likely to contribute MAI to at least one signal of interest. The interference selectors 602.1-602.M are typically configured to produce a symbol-level output corresponding to one or more MAI channels. Baseband signal reconstruction modules 603.1-603.M process the selected MAI channel symbols to produce a signal that is substantially in the same form as the transmitted baseband signal. Outputs. of the baseband signal reconstruction modules 603.1-603.M may be coupled to an optional pulse-shaping filter 604.1-604.M. Optional channel emulators 605.1-605.M may provide complex gains to the selected channel outputs such as to reproduce the effects of the transmitter and the channel distortion resulting from the propagation channel between the transmitter(s) and the receiver. A weighted-decision combiner 606 provides confidence weights to input MAI-channel signals to produce at least one weighted MAI-channel output that is coupled to each of a plurality M of corresponding Rake fingers.

In an exemplary embodiment of the invention, a first weighted MAI-channel output is coupled into a first stage of a first Rake finger (i.e., Rake Finger₁) 607.1. An M^{th} weighted MAI-channel output is coupled into a first stage 607.M of an M^{th} Rake finger (i.e., Rake Finger_{M}). A projection module 608.1 is coupled between the first stage 607.1 of Rake Finger₁, and a second stage 609.1 of Rake Finger₁. Similarly, a projection module 608.M is coupled between the first stage 607.M of Rake Finger_{M} and a second stage 609.M of Rake Finger_{M}. Those skilled in the art will recognize that a projection module (e.g., the projection modules 608.1-608.M) can be placed anywhere in a receiver chain of a Rake finger, such as shown in FIG. 2A.

Each of the projection modules 608.1-608.M is typically configured to receive a digital baseband signal including a signal of interest, and at least one selected interfering signal. A preferred embodiment of the invention provides for processing the digital baseband signal in substantially the same manner (e.g., with respect to descrambling, despreading, de-multiplexing, space-time processing, etc.) as the selected interfering signals.

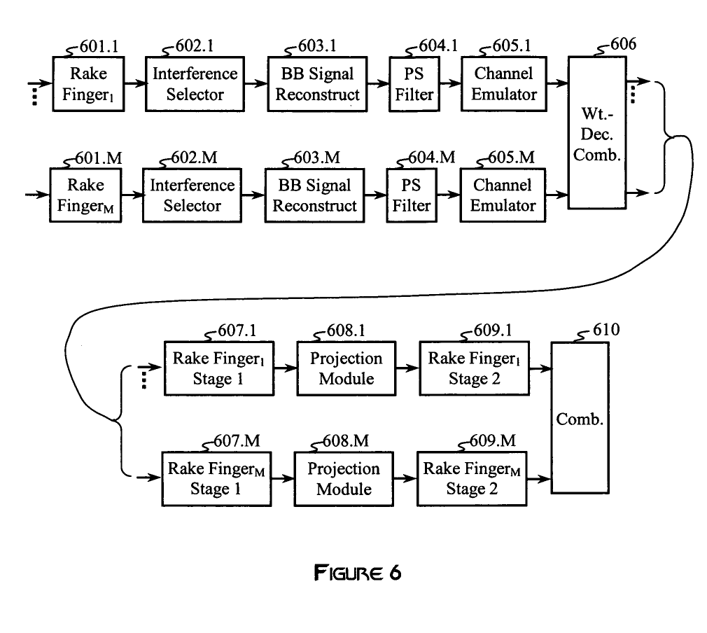

FIG. 7 illustrates an alternate embodiment of the invention wherein projection cancellation is performed in a Rake receiver without a weighted-decision combiner. A received baseband signal is input to a plurality M of Rake fingers 701.1-701.M. Each of a plurality of interference selectors 702.1-702.M is configured to select channels that are likely to contribute MAI to at least one signal of interest. Optional channel emulators 704.1-704.M may provide complex gains to the selected channel outputs such as to reproduce the effects of channel distortion resulting from the propagation channel between the transmitter(s) and the receiver. Baseband signal reconstruction modules 703.1-703.M process the MAI channel symbols to produce a signal that is substantially in the same form as the received baseband signal. Outputs of the baseband signal reconstruction modules 703.1-703.M are coupled to projection operators 705.1-705.M, which produce at least one interference-cancelled signal. Optional pulse shaping filters 706.1-706.M may be included.

Outputs from the projection operators 705.1-705.M or the pulse shaping filters 706.1-706.M may optionally be coupled to one or more Rake fingers, such as Rake fingers 701.1-701.M. Alternatively, auxiliary Rake fingers (not shown) may be employed. The receiver shown in FIG. 7 may employ an optional estimation/control algorithm (not shown) to direct signals output by the projection operators 705.1-705.M (or the pulse shaping filters 706.1-706.M) to particular Rake fingers.

In some embodiments of the invention, the projection operators 705.1-705.M may be placed at any of various positions within the baseband signal reconstruction modules 703.1-703.M. The baseband signal reconstruction modules 703.1-703.M may be separated into discrete baseband-reconstruction components configured to perform various operations, such as spreading, scrambling, channel emulation, etc. Thus, the projection operators 705.1-705.M may be configured to process at least one selected interference signal and at least one digital baseband signal comprising at least one signal of interest in a manner corresponding to where the projection operators 705.1-705.M are located within each baseband signal reconstruction module 703.1-703.M.

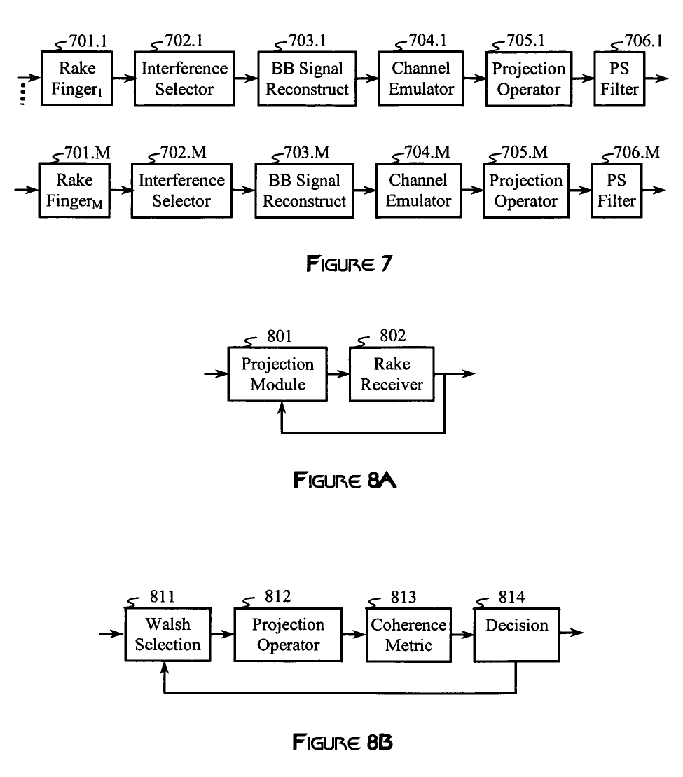

FIG. 8A illustrates an iterative-feedback receiver according to one embodiment of the invention. A projection module 801 of the invention may be configured to operate with a Rake receiver 802 wherein estimates of interfering signals produced by the Rake receiver 802 are fed back to the projection module 801 and used to cancel interference in a received baseband signal. The Rake receiver 802 may be configured to produce at least one estimated interfering signal and an interference-cancelled signal of interest. The projection module 801 and/or the Rake receiver 802 may employ a performance metric (such as a bit error rate, coherence, or some other signal quality measurement) and/or a maximum number of iterations that needs to be satisfied before the interference-cancelled signal is output from the feedback loop. For example, the receiver may function in a feedback mode that performs successive interference cancellation, or attempts to improve the accuracy of interference estimates until the performance metric or the maximum number of iterations is achieved. A current or recent version of the interference-cancelled signal of interest may then be routed to a detector or another signal processor.

In some embodiments of the invention, a successive approximation method may be employed to construct the projection operator. For example, the number of columns in the S matrix may be progressively increased or decreased with each iteration of the successive approximation method. That is, Sᵢ=[Sᵢ₋₁,Sᵢ] or Sᵢ₋₁=[Sᵢ,Sᵢ]. In embodiments of the invention configured to produce a CIV s from S, successive approximation may include progressively increasing or decreasing the number of MAI channels (e.g., Walsh channels) in the linear combination. For example, sᵢ=sᵢ₋₁+sᵢbᵢ or sᵢ₋₁=sᵢ+sᵢb₁. Those skilled in the art will recognize other successive approximation methods that may be applied to embodiments of the present invention.

Any of various metrics may be used to control the iterative process. A preferred metric is a coherence measure that indicates the strength of the signal of interest relative to the total power in the base-band signal after performing each projection. A coherence measure ξ for a one-dimensional code space c is given by

$$\begin{matrix}{ξ}_{S} = \frac{{y}^{H} {P}_{{P}_{{S}_{i}}^{⊥} c} y}{{y}^{H} {P}_{{S}_{i}}^{⊥} y} \\ = \frac{{y}^{H} {P}_{{S}_{i}}^{⊥} {c ( {c}^{H} {P}_{{S}_{i}}^{⊥} c )}^{- 1} {c}^{H} {P}_{{S}_{i}}^{⊥} y}{{y}^{H} {P}_{{S}_{i}}^{⊥} y} \\ = \frac{{\vert {y}^{H} {P}_{{S}_{i}}^{⊥} c \vert}^{2}}{( {y}^{H} {P}_{{S}_{i}}^{⊥} y ) ( {c}^{H} {P}_{{S}_{i}}^{⊥} c )}\end{matrix}$$

where Sᵢ is an interference matrix or vector for an i^{th} iteration of the successive approximation step, c is a desired code vector, and y is a complex base-band signal. In the case of a predetermined maximum number of iterations being reached, a choice of Sᵢ may be made that maximizes ξ. In a preferred embodiment, a pilot channel is selected as c. Alternatively, a traffic channel may be used to construct c.

FIG. 8B shows an embodiment of the invention configured to perform a successive approximation of a projection operator. An estimated active Walsh set is sent as an input to a Walsh selection block 811 configured to select a subset of active Walsh channels. The subset of active Walsh channels is input to a projection operator 812. Optional amplitude information for each selected Walsh channel may also be input to the projection operator 812. A coherence metric block 813 computes the metric and passes it on to a decision block 814, which compares the coherence input to a threshold. If the coherence input is greater than the threshold, a corresponding interference-cancelled baseband signal is output. Otherwise, the Walsh selection block 811 may be directed to perform a next iteration.

Various embodiments of the invention may include variations in system configurations and the order of steps in which methods are provided. In many cases, multiple steps and/or multiple components may be consolidated. Successive approximations of a projection shown herein may also include performing only a single iteration for a selected interference matrix S or a CIV s.

The method and system embodiments described herein merely illustrate particular embodiments of the invention. It should be appreciated that those skilled in the art will be able to devise various arrangements, which, although not explicitly described or shown herein, embody the principles of the invention and are included within its spirit and scope. Furthermore, all examples and conditional language recited herein are intended to be only for pedagogical purposes to aid the reader in understanding the principles of the invention. This disclosure and its associated references are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be appreciated by those skilled in the art that the block diagrams herein represent conceptual views of illustrative circuitry, algorithms, and functional steps embodying principles of the invention. Similarly, it should be appreciated that any flow charts, flow diagrams, signal diagrams, system diagrams, codes, and the like represent various processes that may be substantially represented in computer-readable medium and so executed by a computer or processor, whether or not such computer or processor is explicitly shown.

The functions of the various elements shown in the drawings, including functional blocks labeled as “processors” or “systems,” may be provided through the use of dedicated hardware as well as hardware capable of executing software in association with appropriate software. When provided by a processor, the functions may be provided by a single dedicated processor, by a shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, the function of any component or device described herein may be carried out through the operation of program logic, through dedicated logic, through the interaction of program control and dedicated logic, or even manually, the particular technique being selectable by the implementer as more specifically understood from the context.

Any element expressed herein as a means for performing a specified function is intended to encompass any way of performing that function including, for example, a combination of circuit elements which performs that function, or software in any form, including, therefore, firmware, micro-code or the like, combined with appropriate circuitry for executing that software to perform the function. Embodiments of the invention as described herein reside in the fact that the functionalities provided by the various recited means are combined and brought together in the manner which the operational descriptions call for. Applicant regards any means that can provide those functionalities as equivalent to those shown herein.

1. A cancellation method comprising:
providing a received signal that is decomposable into a signal of interest and a plurality of MAI-channel signals,
providing for applying a confidence weight to each of the plurality of MAI-channel signals to produce a plurality of weighted MAI channel signals, and
providing for projecting the received signal onto a signal space constructed from an interference-signal space corresponding to the plurality of weighted MAI channel signals to determine a parameter of the signal of interest.

2. The cancellation method recited in claim 1, wherein providing for projecting the received signal comprises providing for constructing the signal space to be orthogonal or oblique to the interference-signal space.

3. The cancellation method recited in claim 1, wherein providing a received signal comprises providing for performing Rake reception.

4. The cancellation method recited in claim 1, wherein providing for applying a confidence weight further comprises providing for combining the plurality of weighted MAI channel signals to produce at least one of an interference matrix and a combined interference vector.

5. The cancellation method recited in claim 1, wherein providing for applying a confidence weight comprises at least one of providing for determining complex weights of each of the plurality of MAI-channel signals and determining estimation errors for each of the complex weights.

6. The cancellation method recited in claim 1, wherein providing a received signal includes providing for at least one multi-antenna operation comprising diversity combining and beam forming.

7. The cancellation method recited in claim 1, wherein providing for projecting the received signal is provided over at least one time interval, including a data-symbol interval, an integer multiple of the data-symbol interval, and a fraction of the data-symbol interval.

8. The cancellation method recited in claim 1, wherein providing for applying a confidence weight further comprises providing for producing a linear combination of the plurality of weighted MAI channel signals.

9. A digital computer system programmed to perform the method recited in claim 1.

10. A computer-readable medium storing a computer program implementing the method of claim 1.

11. A cancellation method comprising:
providing a received signal that is decomposable into a signal of interest and at least one interference component,
providing for applying a linear transformation to the at least one interference component to produce an at least one linearly transformed interference component, and
providing for projecting the received signal onto a signal space constructed from an interference-signal space corresponding to the at least one interference component to determine a parameter of the signal of interest.

12. The cancellation method recited in claim 11, wherein providing for projecting the received signal comprises providing for constructing the signal space to be orthogonal or oblique to the interference-signal space.

13. The cancellation method recited in claim 11, wherein providing for applying a linear transformation comprises providing for applying at least one of a left linear transformation and a right linear transformation.

14. The cancellation method recited in claim 11, wherein providing a received signal includes providing for performing at least one multi-antenna operation comprising diversity combining and beam forming.

15. The cancellation method recited in claim 11, wherein providing for projecting the received signal includes performing a projection over at least one time interval, including a data-symbol interval, an integer multiple of the data-symbol interval, and a fraction of the data-symbol interval.

16. A digital computer system programmed to perform the method recited in claim 11.

17. A computer-readable medium storing a computer program implementing the method of claim 11.

18. A method for producing a threshold from a received signal comprising:
detecting at least one of a plurality of traffic channels in the received signal for producing at least one detected traffic channel, and
selecting one or more of the at least one detected traffic channel for threshold determination according to predetermined criteria to produce at least one selected traffic channel.

19. The method recited in claim 18, wherein the received signal is a CDMA signal and the plurality of traffic channels comprise CDMA codes.

20. The method recited in claim 18, wherein the predetermined criteria comprises measured power in the at least one detected traffic channel exceeding a predetermined value.

21. The method recited in claim 18, wherein detecting at least one of a plurality of traffic channels further comprises providing at least one symbol estimate for the at least one detected traffic channel.

22. The method recited in claim 21, wherein detecting at least one of a plurality of traffic channels further comprises summing absolute values of I and Q components of the at least one symbol estimate.

23. The method recited in claim 18, wherein selecting one or more of the at least one detected traffic channel further comprises accounting for signal distortions in the at least one detected traffic channel.

24. The method recited in claim 18, further comprising determining at least one threshold from the at least one selected traffic channel.

25. The method recited in claim 24, wherein determining the at least one threshold comprises deriving the at least one threshold from a combination of the at least one detected traffic channel and a predetermined constant-value threshold.

26. The method recited in claim 24, further comprising comparing at least one received traffic channel to the at least one threshold.

27. A digital computer system programmed to perform the method recited in claim 18.

28. A computer-readable medium storing a computer program implementing the method of claim 18.

29. A method for processing a composite signal, the method comprising the steps of:
providing a received signal that is decomposable into a signal of interest and at least one interference component; and
providing for supplying at least one simplifying approximation to a projection operation configured to project the received signal onto a signal space constructed from an interference space comprising the at least one interference component.

30. The method recited in claim 29, wherein the projection operation has a form of P_{S}^{⊥}=(I−S(S^{H}S)⁻¹S^{H}), wherein P_{S}^{⊥} is the projection operation, I is an identity matrix, S is an interference matrix indicative of the at least one interference component, and S^{H} is a Hermitian transpose of the interference matrix.

31. The method recited in claim 29, wherein the projection operation comprises an oblique projection operation.

32. The method for processing a composite signal recited in claim 29, wherein the received signal and the at least one interference component are complex valued, the projection operation being represented by up to eight mathematical expressions.

33. The method for processing a composite signal recited in claim 32, wherein outputs from a plurality of the up to eight mathematical expressions are combined.

34. The method for processing a composite signal recited in claim 29, wherein providing for supplying the at least one simplifying approximation includes providing at least one of a set of approximations, including assuming that cross correlations between real and imaginary parts of the received signal are negligible, assuming that cross correlations between real and imaginary parts of an interference matrix are negligible, assuming that cross correlations between a real part of the received signal and an imaginary part of the interference matrix are negligible, and assuming that cross correlations between an imaginary part of the received signal and a real part of the interference matrix are negligible.

35. The method for processing a composite signal recited in claim 29, further comprising providing for simplifying the projection operation by making approximations Sᵢ^{T}Sᵢ=S_{q}^{T}S_{q} and Sᵢ^{T}Yᵢ=S_{q}^{T}Y_{q}, where Sᵢ is a real part of an interference matrix, S_{q} is an imaginary part of an interference matrix, Yᵢ is a real part of the received signal, Y_{q} is an imaginary part of the received signal, and ^{T} denotes a transpose operation.

36. The method for processing a composite signal recited in claim 29, wherein providing for supplying the at least one simplifying approximation to the projection operation includes providing for a first operation having a form
$$\frac{{S}_{i}^{T} {Y}_{i}}{{S}_{i}^{T} {S}_{i}}$$
and providing for a second operation having a form
$$\frac{{S}_{q}^{T} {Y}_{q}}{{S}_{q}^{T} {S}_{q}} ,$$
where Sᵢ is a real part of an interference matrix, S_{q} is an imaginary part of the interference matrix, yᵢ is a real part of the received signal, y_{q} is an imaginary part of the received signal, and ^{T} denotes a transpose operation.

37. The method for processing a composite signal recited in claim 29, wherein providing a received signal includes providing for at least one multi-antenna operation comprising diversity combining and beam forming.

38. The method for processing a composite signal recited in claim 29, wherein providing for supplying the at least one simplifying approximation to the projection operation includes configuring the projection operation to operate over at least one time interval, including a data-symbol interval, an integer multiple of a data-symbol interval, and a fraction of a data-symbol interval.

39. A digital computer system programmed to perform the method recited in claim 29.

40. A computer-readable medium storing a computer program implementing the method of claim 29.

41. A cancellation system comprising:
a Rake receiver configured to decompose a received signal into a plurality of signal paths, including at least one signal-of-interest path and a plurality of MAI-channel paths,
a weighted decision combiner configured to apply a confidence weight to each of the plurality of MAI-channel paths to produce a plurality of weighted MAI-channel signals, and
a projection operator configured for projecting a signal space corresponding to the received signal onto a signal space constructed from an interference-signal space corresponding to the plurality of weighted MAI-channel signals.

42. The cancellation system recited in claim 41, wherein the projection operator is further configured to construct the signal space to be orthogonal or oblique to the interference-signal space.

43. The cancellation system recited in claim 41, wherein the Rake receiver includes at least one multi-antenna receiver configured to provide at least one of diversity combining and beam forming.

44. The cancellation system recited in claim 41, further comprising a delay element coupled between the Rake receiver and the projection operator and configured to impart a predetermined delay to the received signal processed by the projection operator.

45. The cancellation system recited in claim 41, wherein the Rake receiver includes at least one of a pulse-shaping filter, a combiner, and a searcher/tracker module.

46. The cancellation system recited in claim 41, wherein the projection operator includes at least one of a combiner and an interference selector.

47. The cancellation system recited in claim 41, further comprising at least one of an interference selector, a channel emulator, a baseband signal reconstruction module, and a pulse-shaping filter.

48. The cancellation system recited in claim 41, wherein the weighted decision combiner and the projection operator are coupled between at least one of a pair of system components, including a sampler and a descrambler, a channel compensator and a descrambler, a descrambler and a demultiplexer, and a demultiplexer and a gain-correction module.

49. The cancellation system recited in claim 41, wherein the Rake receiver and the projection operator are configured with an iterative feedback loop.

50. The cancellation system recited in claim 41, further comprising a linear transformation coupled between the weighted decision combiner and the projection operator.

51. The cancellation system recited in claim 41 configured to process at least one of a set of signals, including cdmaOne, cdma2000, 1xRTT, cdma 1xEV-DO, cdma 1xEV-DV and cdma2000 3x, W-CDMA, Broadband CDMA, UMTS, and GPS signals.

52. A cancellation system comprising:
a receiver configured to provide a received signal that is decomposable into a signal of interest and at least one interference component,
a linear transformation operator configured to apply at least one linear transformation to the at least one interference component to produce an at least one linearly transformed interference component, and
a projection operator configured for projecting the received signal onto a signal space constructed from an interference-signal space corresponding to the at least one interference component to determine a parameter of the signal of interest.

53. The cancellation system recited in claim 52, wherein the projection operator comprises at least one of an orthogonal projection operator and an oblique projection operator.

54. The cancellation system recited in claim 52, wherein the linear transformation operator is configured to apply at least one of a left linear transformation and a right linear transformation.

55. The cancellation system recited in claim 52, wherein the receiver is configured to perform at least one multi-antenna operation comprising diversity combining and beam forming.

56. The cancellation system recited in claim 52, wherein the projection operator is configured to perform a projection over at least one time interval, including a data-symbol interval, an integer multiple of the data-symbol interval, and a fraction of the data-symbol interval.

57. A system for receiving a signal, comprising:
a Rake receiver configured to decompose a received signal into a signal of interest and at least one interference component; and
a projection operator configured for supplying at least one simplifying approximation to a projection operation configured to project the received signal onto a signal space constructed from an interference space comprising the at least one interference component.

58. The system recited in claim 57, wherein the projection operator is further configured to construct the signal space to be orthogonal or oblique to the at least one interference space.

59. The method recited in claim 57, wherein the projection operation has a form of P_{S}^{⊥}=(I−S(S^{H}S)⁻¹S^{H}), wherein P_{S}^{⊥} is the projection operation, I is an identity matrix, S is an interference matrix indicative of the at least one interference component, and S^{H} is a Hermitian transpose of the interference matrix.

60. The system recited in claim 57, wherein the received signal and the at least one interference component are complex valued and the projection operation is expressed by up to eight algebraic operations.

61. The system recited in claim 60, wherein the projection operator includes a combiner configured to combine outputs of the up to eight algebraic operations.

62. The system recited in claim 57, wherein the projection operator is configured to make at least one simplifying assumption of a set including assuming that cross correlations between real and imaginary parts of the received signal are negligible, assuming that cross correlations between real and imaginary parts of an interference matrix are negligible, assuming that cross correlations between a real part of the received signal and an imaginary part of the interference matrix are negligible, and assuming that cross correlations between an imaginary part of the received signal and a real part of the interference matrix are negligible.

63. The system recited in claim 57, wherein the projection operator is configured to make approximations Sᵢ^{T}Sᵢ=S_{q}^{T}S_{q} and Sᵢ^{T}Yᵢ=S_{q}^{T}Y_{q}, where Sᵢ is a real part of the interference matrix, S_{q} is an imaginary part of the interference matrix, Yᵢ is a real part of the received signal, Y_{q} is an imaginary part of the received signal, and ^{T} denotes a transpose operation.

64. The system recited in claim 57, wherein the projection operator is configured to provide a first operation having a form
$$\frac{{S}_{i}^{T} {Y}_{i}}{{S}_{i}^{T} {S}_{i}}$$
and a second operation having a form
$$\frac{{S}_{q}^{T} {Y}_{q}}{{S}_{q}^{T} {S}_{q}} ,$$
where Sᵢ is a real part of the interference matrix, S_{q} is an imaginary part of the interference matrix, Yᵢ is a real part of the received signal, Y_{q} is an imaginary part of the received signal, and ^{T} denotes a transpose operation.

65. The system recited in claim 57, wherein the Rake receiver includes at least one multi-antenna system, including a diversity combiner and a beam-forming processor.

66. The system recited in claim 57, wherein the Rake receiver and the projection operator are configured with an iterative feedback loop.

67. The system recited in claim 57 configured to process at least one of a set of signals, including cdmaOne, cdma2000, 1xRTT, cdma 1xEV-DO, cdma 1xEV-DV and cdma2000 3x, W-CDMA, Broadband CDMA, UMTS, and GPS signals.

68. A handset comprising:
a receiver configured to decompose a received signal into a plurality of signal paths, including at least one signal-of-interest path and a plurality of MAI-channel paths,
a weighted decision combiner configured to apply a confidence weight to each of the plurality of MAI-channel paths to produce a plurality of weighted MAI-channel signals, and
a projection operator configured for projecting a signal space corresponding to the received signal onto a signal space constructed from at least one interference space corresponding to the plurality of weighted MAI-channel signals.

69. The handset recited in claim 68, wherein the projection operator is further configured to construct the signal space from a linear combination of the plurality of weighted MAI-channel signals.

70. The handset recited in claim 68, wherein the projection operator is configured to construct the signal space to be orthogonal or oblique to the at least one interference space.

71. The handset recited in claim 68, wherein the receiver includes at least one multi-antenna receiver configured to provide at least one of diversity combining and beam forming.

72. The handset recited in claim 68, further comprising a delay element coupled between the receiver and the projection operator and configured to impart a predetermined delay to the received signal processed by the projection operator.

73. The handset recited in claim 68, wherein the receiver includes at least one of a pulse-shaping filter, a combiner, and a searcher/tracker module.

74. The handset recited in claim 68, wherein the projection operator includes at least one of a combiner and an interference selector.

75. The handset recited in claim 68, further comprising at least one of an interference selector, a channel emulator, a baseband signal reconstruction module, and a pulse-shaping filter.

76. The handset recited in claim 68, wherein the weighted decision combiner and the projection operator are coupled between at least one of a pair of system components, including a sampler and a descrambler, a channel compensator and a descrambler, a descrambler and a demultiplexer, and a demultiplexer and a gain-correction module.

77. The handset recited in claim 68, wherein the receiver and the projection operator are configured with an iterative feedback loop.

78. The handset recited in claim 68, further comprising a linear transform operator coupled between the weighted decision combiner and the projection operator.

79. The cancellation system recited in claim 68 configured to process at least one of a set of signals, including cdmaOne, cdma2000, 1xRTT, cdma 1xEV-DO, cdma 1xEV-DV and cdma2000 3x, W-CDMA, Broadband CDMA, UMTS, and GPS signals.

80. A handset configured for receiving a signal, comprising:
a receiver configured to decompose a received signal into a signal of interest and at least one interference component; and
a projection operator configured for supplying at least one simplifying approximation to a projection operation, the projection operator configured to project the received signal onto a signal space constructed from an interference space comprising the at least one interference component.

81. The handset recited in claim 80, wherein the projection operator is further configured to construct the signal space from a linear combination of a plurality of the at least one interference component.

82. The handset recited in claim 80, wherein the projection operator is configured to construct the signal space to be orthogonal or oblique to the at least one interference space.

83. The method recited in claim 80, wherein the projection operation has a form of P_{S}^{⊥}=(I−S(S^{H}S)⁻¹S^{H}), wherein P_{S}^{⊥} is the projection operation, I is an identity matrix, S is an interference matrix indicative of the at least one interference component, and S^{H} is a Hermitian transpose of the interference matrix.

84. The handset recited in claim 80, wherein the received signal and the at least one interference component are complex valued and the projection operator is a complex operator expressed by up to eight algebraic operations.

85. The handset recited in claim 84, wherein the projection operator includes a combiner configured to combine outputs of the up to eight algebraic operations.

86. The handset recited in claim 80, wherein the projection operator is configured to make at least one simplifying assumption of a set of assumptions, including assuming that cross correlations between real and imaginary parts of the received signal are negligible, assuming that cross correlations between real and imaginary parts of the interference matrix are negligible, assuming that cross correlations between a real part of the received signal and an imaginary part of the interference matrix are negligible, and assuming that cross correlations between an imaginary part of the received signal and a real part of the interference matrix are negligible.

87. The handset recited in claim 80, wherein the projection operator is configured to simplify the projection operator by making approximations Sᵢ^{T}Sᵢ=S_{q}^{T}S_{q} and Sᵢ^{T}Yᵢ=S_{q}^{T}Y_{q}, where Sᵢ is a real part of an interference matrix, S_{q} is an imaginary part of the interference matrix, Yᵢ is a real part of the received signal, Y_{q} is an imaginary part of the received signal, and ^{T} denotes a transpose operation.

88. The handset recited in claim 80, wherein the projection operator is configured to provide a first operation having a form
$$\frac{{S}_{i}^{T} {Y}_{i}}{{S}_{i}^{T} {S}_{i}}$$
and a second operation having a form
$$\frac{{S}_{q}^{T} {Y}_{q}}{{S}_{q}^{T} {S}_{q}} ,$$
where Sᵢ is a real part of an interference matrix, S_{q} is an imaginary part of the interference matrix, Yᵢ is a real part of the received signal, Y_{q} is an imaginary part of the received signal, and ^{T} denotes a transpose operation.

89. The handset recited in claim 80, wherein the receiver includes at least one multi-antenna system, including a diversity combiner and a beam-forming processor.

90. The handset recited in claim 80, wherein the receiver and the projection operator are configured with an iterative feedback loop.

91. The handset recited in claim 80, configured to process at least one of a set of signals, including cdmaOne, cdma2000, 1xRTT, cdma 1xEV-DO, cdma 1xEV-DV and cdma2000 3x, W-CDMA, Broadband CDMA, UMTS, and GPS signals.

92. A threshold detector configured to generate a threshold from a received signal, the threshold detector comprising:
a multiple-access interference selection module configured for detecting at least one of a plurality of traffic channels in the received signal for producing at least one detected traffic channel, and selecting one or more of the at least one detected traffic channel for threshold determination according to predetermined criteria to produce at least one selected traffic channel.

93. The threshold detector recited in claim 92 configured to process a CDMA signal, wherein the plurality of traffic channels comprise CDMA codes.

94. The threshold detector recited in claim 92, wherein the predetermined criteria comprises measured power in the at least one detected traffic channel exceeding a predetermined value.

95. The threshold detector recited in claim 92, wherein the multiple-access interference selection module is configured to provide at least one symbol estimate for the at least one detected traffic channel.

96. The threshold detector recited in claim 95, wherein the multiple-access interference selection module is configured to sum absolute values of I and Q components of the at least one symbol estimate.

97. The threshold detector recited in claim 92, wherein the multiple-access interference selection module is configured to account for signal distortions in the at least one detected traffic channel.

98. The threshold detector recited in claim 92, wherein the multiple-access interference selection module is configured for determining at least one threshold from the at least one selected traffic channel.

99. The threshold detector recited in claim 98, wherein determining the at least one threshold comprises deriving the at least one threshold from a combination of the at least one detected traffic channel and a predetermined constant-value threshold.

100. The threshold detector recited in claim 98, further configured to compare at least one received traffic channel to the at least one threshold.

101. A handset comprising:
a receiver configured to provide a received signal that is decomposable into a signal of interest and at least one interference component,
a linear transformation operator configured to apply at least one linear transformation to the at least one interference component to produce an at least one linearly transformed interference component, and
a projection operator configured for projecting the received signal onto a signal space constructed from an interference-signal space corresponding to the at least one interference component to determine a parameter of the signal of interest.

102. The handset recited in claim 101, wherein the projection operator comprises at least one of an orthogonal projection operator and an oblique projection operator.

103. The handset recited in claim 101, wherein the linear transformation operator is configured to apply at least one of a left linear transformation and a right linear transformation.

104. The handset recited in claim 10 1, wherein the receiver is configured to perform at least one multi-antenna operation comprising diversity combining and beam forming.

105. The handset recited in claim 101, wherein the projection operator is configured to perform a projection over at least one time interval, including a data-symbol interval, an integer multiple of the data-symbol interval, and a fraction of the data-symbol interval.

106. The handset recited in claim 101 configured to process at least one of a set of signals, including cdmaOne, cdma2000, 1xRTT, cdma 1xEV-DO, cdma 1xEV-DV and cdma2000 3x, W-CDMA, Broadband CDMA, UMTS, and GPS signals.
